(19) United States
(12) Patent Application Publication
(10) Pub. No.: US 2017/0055549 A1
(43) Pub. Date: Mar. 2, 2017

(54) METHOD FOR MANUFACTURING INSTANT SAMGYETANG

(71) Applicant: Harim Co., Ltd., Jeollabuk-do (KR)

(72) Inventor: Hong Dae JUNG, Jeollabuk-do (KR)

(21) Appl. No.: 14/872,152

(22) Filed: Oct. 1, 2015

(30) Foreign Application Priority Data
Sep. 1, 2015 (KR) 10-2015-0123389

(51) Int. Cl. A23B 4/044

(52) U.S. Cl. CPC A23L 1/39; A23L 1/315; A23L 1/221; A23B 4/044; A23V 2002/00

(57) ABSTRACT

A method for manufacturing an instant samgyetang smoked with oak chips, wherein when sub-ingredients are put into the stomach of a chicken, oak chips are burnt to generate smoke in a state where the chicken is put into a smoking and boiling apparatus, and when a surface of the chicken is processed with the smoke generated from the oak chips, the chicken, sub-ingredients and a seasoning source are filled in a package for sterilization and quick freezing.

### TECHNICAL FIELD

The present invention relates to an instant samgyetang smoked with oak chips and a method for manufacturing the same, and more specifically to an instant samgyetang smoked with oak chips and a method for manufacturing the same, where a surface of a chicken, which is raw meat used for samgyetang, is smoked with smoke generated when burning the oak chips, thereby removing the chicken's peculiar odor and impure taste and allowing an instant samgyetang with better taste made by flavor from the oak chips.

### BACKGROUND ART

Samgyetang has been known as a healthy food for unenergetic people. Specifically, samgyetang is good for people who have cold body and are sensitive to cold, who get thinner, who sweat well, who get tired easily, who do not have a balanced diet, or who lacks concentration. Specifically, samgyetang is a traditional food whose efficacy on energy recovery for people who have weak energy or have no appetite, for mothers before and after delivery, and for patients who are ill in bed is proved. Since samgyetang is effective for recovering energy that can be easily used up in the summer season, it is sold well during the summertime.

The main ingredient of samgyetang, the chicken, includes thin and soft fibers constituting meat quality. Additionally, since lipid is not mixed into muscles, the chicken is a protein food whose taste is light and absorption after digestion is also good. Pregnant women who need good quality of protein and ingestion of lipid have put the chicken into the Korean seaweed soup. Also, the chicken has essential amino acids including methionine, so it is effective for having new skin come up. Especially, the chicken's protein contains a lot of linoleic acids among fatty acids, so it is good for preventing adult diseases and suitable for foods for elderly people and patients. The chicken also includes a lot of vitamins A, B₁, and B₂, and Niasin. Furthermore, mucin which is found the most from the chicken's wings promotes growth, increases sexual function or motor skills, and increases absorption of protein.

Since it takes a lot of time and efforts to cook samgyetang having the good efficacy, it is inconvenient to enjoy eating samgyetang in a modern life style. Accordingly, there have been various attempts to develop a method for manufacturing an instant samgyetang which can be ingested simply within a short time without a complex cooking procedure. As a result thereof, various processed foods of samgyetang have been developed as conventional convenient foods.

The conventional instant samgyetang has an advantage that samgyetang can be cooked simply and easily, but the taste thereof is greatly decreased due to the chicken's peculiar odor and impure taste.

### PRIOR ART

### Patent Document

[Patent Document 1] Korean Patent No. 10-1217651 (Dec. 26, 2012)

[Patent Document 2] Korean Patent No. 10-1264985 (May 9, 2013)

### SUMMARY OF INVENTION

It is an object of the present invention to provide an instant samgyetang smoked with oak chips and a method for manufacturing the same, where a surface of a chicken, which is raw meat used for samgyetang, is smoked with smoke generated when burning the oak chips, thereby removing the chicken's peculiar odor and impure taste and allowing an instant samgyetang with better taste made by flavor from the oak chips.

In order to achieve the above object, the present invention provides an instant samgyetang smoked with oak chips and a method for manufacturing the same, including that when sub-ingredients are put into the stomach of a chicken, oak chips are burnt to generate smoke in a state where the chicken is put into a smoking and boiling apparatus, and when a surface of the chicken is processed with the smoke generated from the oak chips, the chicken, sub-ingredients and a seasoning source are filled in a package for sterilization and quick freezing.

Also, the present invention includes the steps of preparing ingredients of a chicken, which is raw meat, sub-ingredients, a seasoning source and oak chips containing about 5 to 20% of water; when the ingredients are prepared, putting the sub-ingredients into the chicken's stomach and putting the chicken stuffed with the sub-ingredients into a smoking and boiling apparatus; when the chicken is put into the smoking and boiling apparatus, burning the oak chips under a smoking process condition at a temperature of 60 to 80° C. for 1 to 10 minutes to generate smoke so that the surface of the chicken is processed with the smoke; putting steam into the smoking and boiling apparatus to prevent the surface of chicken from being dried; and when the smoking process is done, spraying cooling water onto the surface of the chicken to remove fat and foreign substances from the surface, filling the chicken, seasoning source and fresh ginseng, which is a sub-ingredient, in a package, and sealing the package.

As stated above, according to the present invention, the surface of the chicken, which is the raw meat used for samgyetang, is processed with smoke generated when burning the oak chips, and the smoked chicken is vacuum-packed to be sold in the market. Accordingly, since the surface of chicken is processed with smoke generated from the oak chips, the chicken's peculiar odor and impure taste are removed, and also the instant samgyetang with better taste due to the flavor from the oak chips can be cooked and eaten.

Hereinafter, the present invention will be explained in detail with reference to embodiments of the present invention.

The present invention provides an instant samgyetang smoked with oak chips and a method for manufacturing the same, including that when sub-ingredients are put into the stomach of a chicken, oak chips are burnt to generate smoke in a state where the chicken is put into a smoking and boiling apparatus, and when a surface of the chicken is processed with the smoke generated from the oak chips, the chicken, sub-ingredients and a seasoning source are filled in a package for sterilization and quick freezing.

Additionally, the present invention includes the steps of preparing ingredients of a chicken, which is raw meat, sub-ingredients, a seasoning source and oak chips containing about 5 to 20% of water; when the ingredients are prepared, putting the sub-ingredients into the chicken's stomach and putting the chicken stuffed with the sub-ingredients into a smoking and boiling apparatus; when the chicken is put into the smoking and boiling apparatus, burning the oak chips under a smoking process condition at a temperature of 60 to 80° C. for 1 to 10 minutes to generate smoke so that the surface of the chicken is processed with the smoke; putting steam into the smoking and boiling apparatus to prevent the surface of chicken from being dried; and when the smoking process is done, spraying cooling water onto the surface of the chicken to remove fat and foreign substances from the surface, filling the chicken, seasoning source and fresh ginseng, which is a sub-ingredient, in a package, and sealing the package.

Each step will be explained in detail as below.

### 1. Preparing Ingredients

A chicken, which is raw meat, sub-ingredients, a seasoning source (meat stock) and oak chips are prepared.

Young chicken for samgyetang is purchased from the place of origin or agricultural & livestock market, the chicken is slaughtered with feathers, feet, neck, uropygial gland, inedible parts in the stomach removed, and 300 g to 500 g of chicken is used. The slaughtered chicken has no bruise in appearance, and the chicken does not include any fractured part.

Glutinous rice, fresh ginseng and jujube are the sub-ingredients, and oak chips having about 3 mm wide and about 5 mm long with about 5 to 30% of water are used.

As the seasoning source, 30% of chicken stock and 70% of purified water are diluted, the diluted seasoning source is boiled at a temperature of 80 to 100° C. for 3 to 4 minutes, sun-dried salt, white sugar, and white pepper are put in the source, and then the seasoning source is boiled again for 3 to 4 minutes to be dissolved.

### 2. Preparing Smoking Process

When the ingredients are prepared, after the sub-ingredients such as jujube and about 30 to 60 g of washed glutinous rice are put into the chicken's stomach, the skin at the bottom of one leg is incised and another leg is inserted into the incised portion to make “X” shape, so that the sub-ingredients cannot be come out. Afterwards, the chicken stuffed with the sub-ingredients is put into the inside of the smoking and boiling apparatus.

### 3. Smoking Process

When the chicken is put in the smoking and boiling apparatus, the oak chips are burnt under a smoking process condition at a temperature of 60 to 80° C. for 1 to 10 minutes to generate smoke. The smoke generated while burning the oak chips will have the surface of the chicken smoked. At this time, during the smoking process, the chicken's peculiar odor and impure taste are removed, and the flavor of oak chips is permeated into the surface of the chicken.

### 4. Preventing the Surface From Being Dried

At this time, during the smoking process, steam is put into the chicken which is smoked inside the smoking and boiling apparatus to prevent the chicken's surface from being dried.

### 5. Vacuum Packaging

When the smoking process is completed, fat and foreign substances on the chicken's surface are removed by spraying cooling water thereto. Afterwards, the chicken with smoked surface, seasoning source and fresh ginseng are filled in a package. At this time, the seasoning source is filled in the package until the total weight is 800 g or greater, and the package is sealed after adjusting a final weight of samgyetang.

The sealed product is sterilized at a temperature of 80 to 110° C. for 30 to 50 minutes, cooled for 20 to 40 minutes, and then sold in the market.

It should be understood that the detailed description of the present invention as described above is by way of example only, and is not intended to limit the scope of the present invention. The scope of the present invention is defined by the foregoing claims, and it is intended that the present invention covers the modifications or variations of the present invention provided they come within the scope of the appended claims and their equivalents.

1. A method for manufacturing an instant samgyetang smoked with oak chips, wherein when sub-ingredients are put into the stomach of a chicken, oak chips are burnt to generate smoke in a state where the chicken is put into a smoking and boiling apparatus, and when a surface of the chicken is processed with the smoke generated from the oak chips, the chicken, sub-ingredients and a seasoning source are filled in a package for sterilization and quick freezing.

2. An instant samgyetang smoked with oak chips and a method for manufacturing the same, comprising:
preparing ingredients of a chicken, which is raw meat, sub-ingredients, a seasoning source and oak chips containing about 5 to 20% of water;
when the ingredients are prepared, putting the sub-ingredients into the chicken's stomach and putting the chicken stuffed with the sub-ingredients into a smoking and boiling apparatus;
when the chicken is put into the smoking and boiling apparatus, burning the oak chips under a smoking process condition at a temperature of 60 to 80° C. for 1 to 10 minutes to generate smoke so that the surface of the chicken is processed with the smoke;
putting steam into the inside of the smoking and boiling apparatus to prevent the surface of chicken from being dried; and
when the smoking process is done, spraying cooling water onto the surface of the chicken to remove fat and foreign substances from the surface, filling the chicken, seasoning source and fresh ginseng, which is a sub-ingredient, in a package, and sealing the package.

3. The instant samgyetang smoked with oak chips manufactured by the method according to claim 1.

4. The instant samgyetang smoked with oak chips manufactured by the method according to claim 2.
